(19) United States
(12) Patent Application Publication
(10) Pub. No.: US 2018/0223554 A1
(43) Pub. Date: Aug. 9, 2018

(54) POOL FILTER BRUSH

(71) Applicant: STEPHEN D. AMICO, CRYSTAL LAKE, IL (US)

(72) Inventor: STEPHEN D. AMICO, CRYSTAL LAKE, IL (US)

(21) Appl. No.: 15/426,072

(22) Filed: Feb. 7, 2017

(51) Int. Cl. E04H 4/16; A46B 9/02; A46B 15/00; C02F 1/00; B01D 35/10; B01D 29/56

(52) U.S. Cl. CPC E04H 4/16; A46B 9/026; A46B 15/00; C02F 2103/42; B01D 35/10; B01D 29/56; C02F 1/001

(57) ABSTRACT

The given invention relates to a pool filter guard with a brush that helps to protect the main pool filter basin and the pump of the main pool filter basin from excessive small and large debris that accumulates in the strainer baskets found in main pool filter basin. Herein, the debris is caught on the plurality of the bristles coupled to the brush, so it does not collect against the sides and the bottom of the pool, impeding the flow of water in the main pool filter basin.

### FIELD OF INVENTION

The given invention relates to a pool filter guard with a brush that helps to protect the main pool filter basin and the pump of the main pool filter basin from excessive small and large debris, that accumulates in the strainer baskets found in main pool filter basin. Herein, the debris is caught on the plurality of the bristles coupled to the brush, so it does not collect against the sides and the bottom of the pool, impeding the flow of water in the main pool filter basin.

### BACKGROUND OF THE INVENTION

Everyone enjoys an outdoor swimming pool when weather permits. It is a great way to cool off on a hot summer day, and many enjoy relaxing in heated pools when the weather is cool. Maintaining a pool requires time, effort, and knowledge as there are many tasks that must be monitored to ensure the health of the swimmers and the longevity of the mechanical systems. Debris in the water, like leaves and bugs, must be removed so the water is inviting and the filtering system can work effectively. Owners must skim their pools daily, vacuum the bottom, and constantly empty the small strainer basket, which catches much of the debris as the water circulates through the intake system. When debris is allowed to collect in the strainer basket, it blocks or slows the flow of water through the intake system, causing the main filtering system and pump to work harder and dramatically reducing the main filter system's basic operation and performance.

Moreover when the strainer basket is neglected and overwhelmed with excessive debris and the flow of water is blocked, the main fitter/pump will begin to process air instead of water, which will eventually damage these systems. Also, owners often place covers over their pools at night, and during storms, and seasonal changes to prevent debris from getting into their pools. As the covers are removed, much of the debris on top will float into the pool and needs to be removed manually. It is not recommended to leave the pool cover on all the time as it can lead to algae (especially if a heated pool). Aeration, water circulation, and sunshine are best for good pool water aeration and reducing algae development. Most hotel/public pools do not use pool covers. It is also very inconvenient to remove the cover when wanting to swim, especially when a heated pool is covered during spring and fall, when debris from the landscaping creates a big maintenance problem. In certain regions, excessive weather conditions, like high winds and storms, because a great amount of leaves and debris to accumulate in pools. This will result in the clogging of the main intake basket, impacting the performance and operation of the main filter and pump.

Therefore, there remains a need to overcome above mentioned problems and our invention resolve these entire problems.

### SUMMARY OF THE INVENTION

The main objective of the present invention is to overcome the limitations of the prior arts by providing a pool filter guard which comprises: a housing with a top surface, wherein the top surface defines a small circular opening, enabled to receive a flexible handle that fits through the small circular opening, onto the top surface of the housing and the handle is further coupled to a brush, wherein the brush is enabled to fit inside the housing; plurality of bristle, coupled to the brush; wherein the plurality of bristle extend to side surfaces of the housing; a sliding door coupled to the housing, wherein the sliding door enable providing a specified quantity of water to leave or enter the housing after and before cleaning respectively

In the given invention of the pool filter guard the at least one user willing to use the pool filter guard to clean his/her pool, insert or fit the main pool filter basin with the pool filter guard, wherein the pool filter guard comprises a housing, wherein the housing supports a top surface. The top surface further defines a small circular opening from wherein, a flexible handle pass through. The handle is further coupled to brush, wherein the brush is further coupled to the plurality of the bristle. The housing mentioned herein, is also coupled to a sliding door. Herein, once the at least one user is done with the coupling of the pool filter guard inside the main pool filter basin, the at least one user enables the water to enter the main pool filter basin, wherein the water entering the main pool filer basin passes through the sliding door and enters the housing of pool filter guard. The direction of the water inside the housing is then adjusted with the help of the handle to create a circular flow within the pool like a wide whirlpool effect. This circular flow of water further enables the brush coupled inside the housing to rotate clockwise or anti clockwise, wherein the plurality of the bristle attached to the brush enables removing the debris and other impurities from the water entering the pool filter guard, wherein the debris and large impurity proof water is then again provided to the main pool filter basin via sliding door and the main pool filter basin again cleans and purify the water for further impurities and helps providing a cleaned and impurity proof pool water. The handle attached herein, is also enabled to fix the position of the pool filter guard and also enable removing and reinserting the brush after and before cleaning of the water in the pool.

Moreover, the pool filter guard helps in maintain the longer life span of the main pool filter basin and also enables reducing amount of pool maintenance.

### BRIEF DESCRIPTION OF THE DRAWINGS

For a more complete understanding of embodiment(s), reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 illustrates the perspective view of the given invention according to an embodiment of the invention.

### DETAIL DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

References to “one embodiment,” “at least one embodiment(s),” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

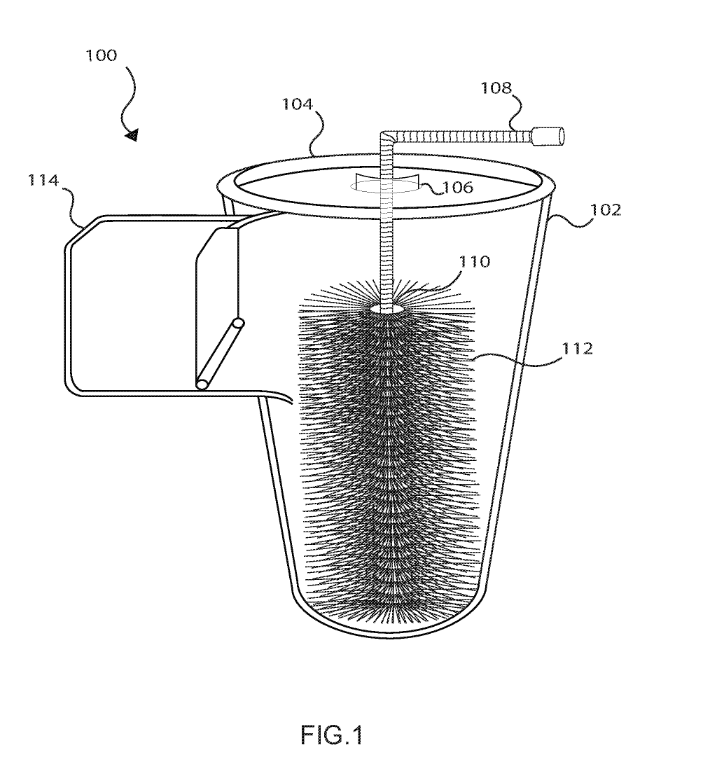

FIG. 1 illustrates the perspective view of the given invention of the pool filter guard [100], wherein the pool filter guard [100] comprises a housing with a top surface [104], wherein the top surface [104] defines a small circular opening [106] enabled to receive a flexible handle [108] that fits through the small circular opening 106], onto the top surface [104] the housing [102] and the flexible handle [108] is further coupled to a brush [110], wherein the brush [110] is enabled to fit inside the housing [102]; plurality of bristle [112], coupled to the brush [110]; wherein the plurality of bristle [112] extend to side surfaces of the housing [102]; a sliding door [114] coupled to the housing [102], wherein the sliding door [114] enable providing a specified quantity of water to leave or enter the housing [102] after and before cleaning respectively. Herein, the pool filter guard [100] is inserted into the main pool filter basin provided on all above or below ground pools. The pool filter guard [100] has a handle [106], a brush [110], wherein the brush [110] is similar to the brushes used for cleaning bottles. The plurality of bristle [112] coupled to the brush, wherein the plurality of the bristle extend to the depending side surface of the housing [102], and the flexible handle [106] fits through the small circular opening [106] on the top surface [104] of the housing [102], which helps to maintain its upright position of the brush [110] in the center of the housing [102]. The flexible handle [108] herein is enabled either to bend or to shorted, so that it is not in the way when the main pool filter basin is on the same level as the walkway around the ground pool. The diameter of the plurality of bristle [112] near the sliding door [112] does not span the full diameter of the housing [102] in order to provide easy movement of the water, of the main pool filter basin inside the housing [102] for purification. Also, there is a % to 1-inch gap from the highest point of the brush [110], where the water level of the pool and main pool filter basin meet (at the sliding door [114]). The gap closes gradually as the brush [110] extends down which further enables larger debris to be captured around the brush [110] as the water circulates around it. Down towards the bottom of the housing [102], smaller debris is enabled to be captured by the plurality of bristle [112] on the brush [110], and even smaller debris is captured from the increased density of the plurality of bristle [112] coupled at the center of the brush [110]. The brush [110] coupled with a handle [108] also works toward the bottom of the housing [102] where the sliding door [114] is attached for the intake of the water. At this point, only very small debris (if any) continues to the main pool filter basin. The brush [110] herein, accommodates the specifications for all main pool filter basin. It completely fills the diameter of the housing [110] at the bottom. Any changes regarding the size and/or adjustments are accommodated as per the intent of the pool filter guard [100]. The pool filter guard [100] covers all the requirements and easily adjusts to the specifications regardless of the variations. The free flow of water is critical to the performance of the main pool filter basin and the pump. The water level in the pool must be maintained at standard recommended levels for optimal performance of debris collection in the pool filter guard [100]. The pool filter guard [100] herein is also, provided to get received inside the main pool filter basin, wherein the pool filter guard [100] is further designed in a manner that it can be directly inserted inside the main pool filter guard. Therefore, no specific designing of the pool filter guard [100] is required to enable the pool filter guard [100] inside the main pool filter basin. Moreover, the pool filter guard [100] enables providing a reduced amount of clogging of the strainer basket, used for collecting debris at the time of cleaning which in turn enable providing proper flow of water inside and outside the pool. The use of pool filter guard [100] inside the pools reduce the use of pool covers and also minimizes the use of vacuum cleaners for cleaning the bottom surface of the pools, wherein this in turn enables reducing the amount of routine maintenance of the pools.

The preferred embodiment of the present invention of the pool filter guard [100]. The at least one user willing to use the pool filter guard [100] to clean his/her pool, insert or fit the main pool filter basin with the pool filter guard [100], wherein the pool filter guard [100] comprises a housing [102], wherein the housing supports a top surface [104]. The top surface [104] further defines a small circular opening [106] from wherein, a flexible handle pass through. The handle is further coupled to brush [110], wherein the brush [110] is further coupled to the plurality of the bristle [112]. The housing [102] mentioned herein, is also coupled to a sliding door [114]. Herein, once the at least one user is done with the coupling of the pool filter guard [100] inside the main pool filter basin, the at least one user enables the water to enter the main pool filter basin, wherein the water entering the main pool filer basin passes through the sliding door [114] and enters the housing [102] of pool filter guard [100]. The direction of the water inside the housing [102] is then adjusted with the help of the handle [108] to create a circular flow within the pool like a wide whirlpool effect. This circular flow of water further enables the brush [110] coupled inside the housing [102] to rotate clockwise or anti clockwise, wherein the plurality of the bristle [112] attached to the brush [110] enables removing the debris and other impurities from the water entering the pool filter guard [100], wherein the debris and large impurity proof water is then again provided to the main pool filter basin via sliding door [114] and the main pool filter basin again cleans and purify the water for further impurities and helps providing a cleaned and impurity proof pool water. The handle [108] attached herein, is also enabled to fix the position of the pool filter guard [100] and also enable removing and reinserting the brush after and before cleaning of the water in the pool.

What is claimed is:

1. A pool filter guard comprises: a housing with a top surface, wherein the top surface defines a small circular opening, a flexible handle that fits through the small circular opening into the housing and the flexible handle is further coupled to a brush having plurality of bristle, wherein the plurality of bristle extend to side surfaces of the housing; and a sliding door, wherein the sliding door enable providing a specified quantity of water to leave or enter the housing after and before cleaning respectively.

2. The pool filter guard in claim 1; wherein the pool filter guard is enabled to get received inside a main pool filter basin, located inside or outside the ground pool.

3. The pool filter guard in claim 1; wherein the plurality of the bristle near the sliding door coupled to the brush has a diameter which does not span the full diameter of the housing to enable easy movement of the water inside and outside the from the housing after cleaning

4. The pool filter guard in claim 1; wherein the housing have a gap from a highest point of the brush, wherein this gap closes gradually as the brush extends down about halfway to the top surface of the housing that allow larger debris to be captured around the brush as the water circulates around it.
